(19) United States
(12) Patent Application Publication
(10) Pub. No.: US 2005/0263190 A1
(43) Pub. Date: Dec. 1, 2005

(54) DOUBLE HEAT TRAP IN UNITARY BODY

(75) Inventors: Edward F. Hammond, Springhill, TN (US); Ray P. Higdon, Franklin, TN (US); Phillip G. Jordon, Rockvale, TN (US); Larry W. Lillard, College Grove, TN (US); Mark A. Murphy, Nashville, TN (US); Daryll K. Swinney, Lewisburg, TN (US)

Correspondence Address: MICHAEL BEST & FRIEDRICH, LLP, 100 E WISCONSIN AVENUE, MILWAUKEE, WI, 53202, US

(73) Assignee: Apcom, Inc., Franklin, TN (US)

(21) Appl. No.: 10/857,103

(22) Filed: May 28, 2004

(51) Int. Cl. F16K 15/14

(52) U.S. Cl. 137/512

(57) ABSTRACT

Abstract of the Disclosure

A heat trap for use in a conduit through which fluid flows. The heat trap comprises a unitary body having a central bore extending therethrough, and first and second blocking portions having on a circumferential edge respective first and second resilient hinge portions. Both of the blocking portions substantially entirely block the central bore when in an at-rest condition. The first and second hinge portions hingedly interconnect the blocking portions to the unitary body in cantilever fashion and permit resilient deflection of the blocking portions on the hinge portions in response to fluid flow through the conduit. The resilient hinges also provide for the resilient return of the blocking portions to the at-rest condition in the absence of fluid flow through the conduit. The unitary body and the first and second blocking portions define therebetween a substantially stagnant zone to resist convective heat transfer from fluid on one side of the stagnant zone to fluid on the other side of the stagnant zone.

### Detailed Description of the Invention

### BACKGROUND OF THE INVENTION

The invention relates to a double heat trap in a unitary body. BRIEF DESCRIPTION OF THE INVENTION

The invention provides a heat trap for use in a conduit through which fluid flows. The heat trap comprises a unitary body having a central bore extending therethrough, and first and second blocking portions having on a circumferential edge respective first and second resilient hinge portions. Both of the blocking portions substantially entirely block the central bore when in an at-rest condition. The first and second hinge portions hingedly interconnect the blocking portions to the unitary body in cantilever fashion and permit resilient deflection of the blocking portions on the hinge portions in response to fluid flow through the conduit. The resilient hinges also provide for the resilient return of the blocking portions to the at-rest condition in the absence of fluid flow through the conduit. The unitary body and the first and second blocking portions define therebetween a substantially stagnant zone to resist convective heat transfer from fluid on one side of the stagnant zone to fluid on the other side of the stagnant zone. BRIEF DESCRIPTION OF THE DRAWINGS

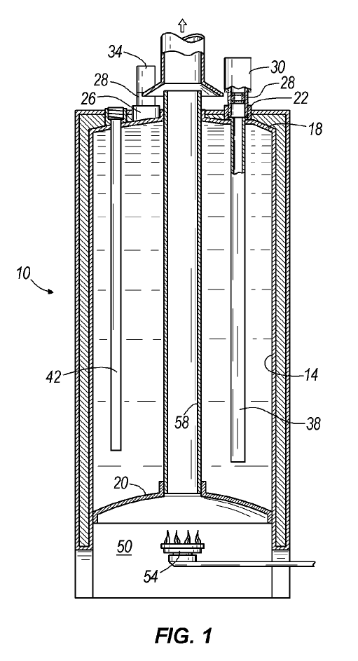

Fig. 1 is cross-section view of a water heater embodying the present invention.

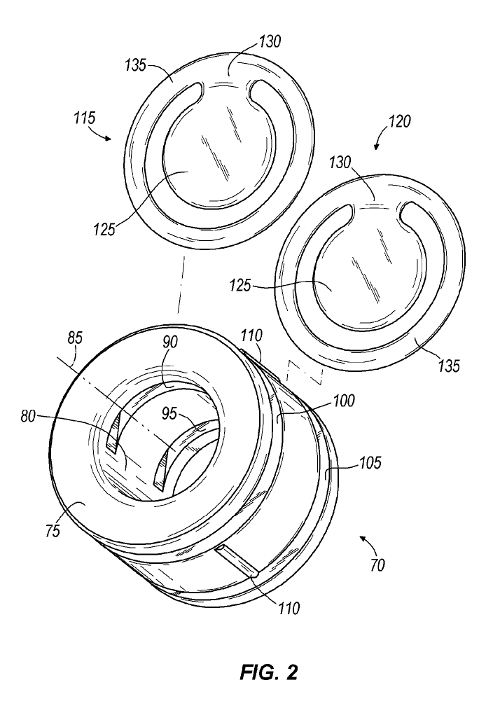

Fig. 2 is an exploded view of a double heat trap for use in the water heater of Fig. 1

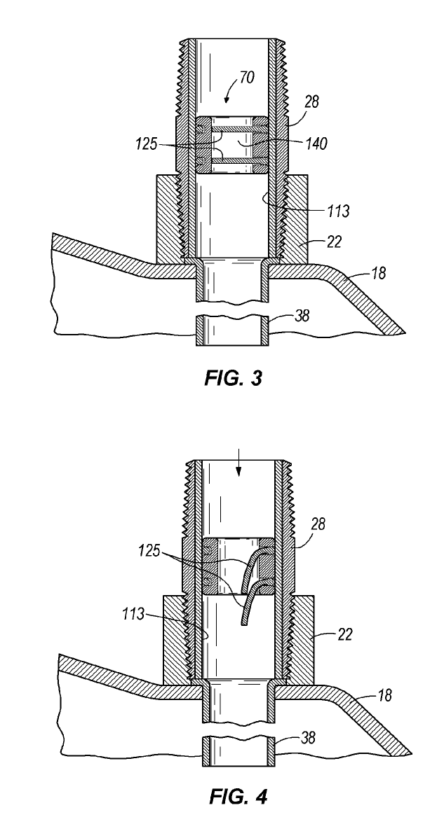

Fig. 3 a cross-section view of the heat trap in a pipe nipple assembly and in an at-rest condition.

Fig. 4 is a cross-section similar to Fig. 3, except showing the heat trap in a deflected condition.

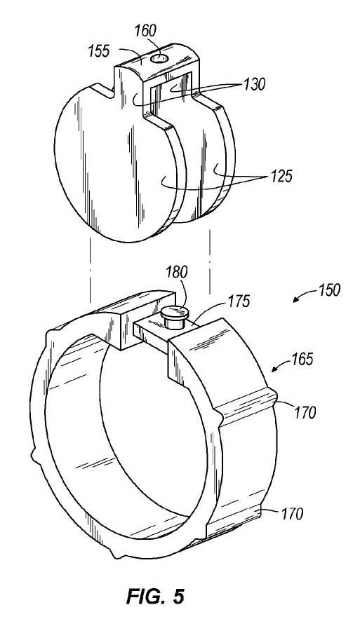

Fig. 5 is an exploded view of an another construction of the double heat trap. DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

Fig 1 illustrates a water heater 10 including a tank 14. The tank 14 has a top wall 18 and a bottom wall 20. The water heater 10 also includes inlet and outlet spuds 22, 26 mounted to the top wall 18. Pipe nipples 28 thread into the spuds 22, 26 and into inlet and outlet pipes 30, 34 for delivery of water to and from the tank 14. The inlet pipe 30 delivers cold water under pressure to the tank 14. The outlet pipe 34 delivers hot water to faucets and other valves when hot water is demanded.

The water heater 10 includes a dip tube 38 communicating with the inlet spud 22 and inlet pipe 30 for the introduction of cold water near the bottom wall 20 of the tank 14, and an anode rod 42 that reduces or eliminates the occurrence of corrosion of the tank walls. A combustion chamber 50 beneath the tank 14 has therein a gas burner 54. A flue 58 extends upwardly through the tank 14 to vent the products of combustion from the combustion chamber 50. The water is heated through the bottom wall 20 of the tank 14 and through the flue walls 58. The water heater 10 may be a power-vented water heater, and include a blower or fan (not shown) in communication with the flue tube 58 to force the flow of combustion products through the flue 58. The invention may also be embodied in an electric water heater having electric heating elements (not shown). An electric water heater would not require the combustion chamber 50, burner 54, and flue tube 58.

Fig. 2 illustrates a double heat trap assembly 70 that is positioned within the inlet and outlet side pipe nipples 28. The double heat trap assembly 70 includes a unitary body 75 having a central bore 80. As used herein, the term “unitary body” means that the entire body is integrally made and not separable without destroying the body. The unitary body may, for example, be an injection molded part and constructed of a material having low thermal conductivity, such as crosslinked polyethylene (also known as "PEX"). The central bore 80 has a circular cross-section in the illustrated embodiment, but may have substantially any cross-section. Regardless of its cross-sectional shape, the central bore is characterized by a longitudinal axis 85.

First and second transverse apertures 90, 95 extend through the unitary body 75, with the first aperture 90 being above the second aperture 95. As used herein with respect to the apertures 90, 95, “above” means that the first and second apertures 90, 95 are generally on the same side of the central bore 80 and the first aperture 90 is longitudinally (using the central bore longitudinal axis 85 as a reference) spaced from the second aperture 95. Also formed in the unitary body 75 are first and second circumferential grooves 100, 105 that intersect the respective first and second apertures 90, 95. The unitary body 75 includes a plurality of equally-spaced ribs or protrusions 110 that tightly engage a polymer (e.g., PEX) liner within the inner bore 113 (see Figs. 3 and 4) of the pipe nipple 28 to ensure a tight press-fit.

The double heat trap 70 also includes a blocking assembly that, in the construction illustrated in Fig. 2, includes first and second separate flappers 115, 120, each including a blocking or tongue portion 125, a resilient hinge portion 130, and a ring portion 135. The flappers 115, 120 are molded of a resilient material, such as rubber. During assembly, the blocking portions 125 are inserted through the respective first and second apertures 90, 95 and the ring portions 135 are looped over the nearest end of the unitary body 75 and fit into the respective grooves 100, 105 so that the ring portions 135 are substantially flush with respect to the outer surface of the unitary body 75. The resilient hinge 130 portions extend through the apertures 90, 95 and support the blocking portions 125 in cantilever fashion across the central bore 80 of the unitary body 75.

With reference to Figs. 3 and 4, both of the blocking portions 125 substantially entirely block the central bore 80 when in an at-rest condition (Fig. 3), but deflect to a deflected condition (Fig. 4) in response to fluid flowing through the central bore 80 (i.e., in response to a hot water draw from the water tank 14). Because the first aperture 100 is above the second aperture 105, the blocking portions 125 do not interfere with each other when pivoting between the at-rest and deflected conditions. The resilient hinge portions 130 provide for the resilient return of the blocking portions 125 to the at-rest condition in the absence of fluid flow through the unitary body 75. When the blocking portions 125 are in the at-rest condition, the unitary body 75 and the first and second blocking portions 125 define therebetween a substantially stagnant zone 140 to resist convective heat transfer from fluid on one side of the stagnant zone 140 to fluid on the other side of the stagnant zone 140. The hinge portions 130 are not directionally sensitive, and the blocking portions 125 may be deflected up or down. Consequently, the identical heat trap assembly 70 may be used in both the inlet and outlet side nipples 28 without regard to which end of the unitary body 75 is up or down. The unitary body 75 of each heat trap acts as a dielectric shield between the pipe 30 or 34 and the tank 14. This is believed to reduce galvanic corrosion between the tank 14 and the pipes 30, 34 and limit anode current draw.

When closed, the low thermal conductivity of the blocking portions 125 material and of the stagnant zone 140 reduces the amount of heat transfer from the heated water in the tank 14 to the inlet and outlet pipes 30, 34 and to the air through conduction. Also, the blocking portions 125 reduce convection currents that cause heated water in the tank 14 to rise into the pipes 30, 34. The blocking portions 125 have sufficient rigidity to resist deflection due to these convection currents.

Fig. 5 illustrates another heat trap assembly 150 with a single-piece blocking assembly. In this construction, the two blocking portions 125 are integrally-molded with a web portion 155 between them, and the web 155 has a small hole 160 through it. This construction also uses a different unitary body construction 165 that is shaped like a ring or collar, and has a plurality of equally-spaced ribs or protrusions 170 that tightly engage the inner bore 113 of the pipe nipple 28 to ensure a tight press fit. A recess, mortise, or channel 175 is formed along one side of the unitary body 165, and has therein a pin or finger 180 that is integrally formed with the unitary body 165. The web 155 fits into the channel 175 with the pin 180 extending through the hole 160 to hold the blocking portions 125 in place. The pin 180 may include an enlarged head that is of slightly larger diameter than the hole 160 such that the material around the hole 160 resiliently deflects to permit the head to pass through the hole 160, and then resiliently retracts around the pin 180 under the head for a more secure fit. In this construction, the portions of the web 155 adjacent the blocking portions 125 serve as the resilient hinges 130.

Alternatively, a combination of the heat trap constructions 70, 150 shown in Figs. 2 and 5 may be employed in which the integral blocking assembly of Fig. 5 is fit into a modified version of the unitary body 75 illustrated in Fig. 2. In this construction, the unitary body 75 of Fig. 2 is modified to remove the circumferential grooves 100, 105 and to add between the apertures 100, 105 the channel and pin arrangement 175, 180 of Fig. 5. The blocking portions 125 of the integral blocking assembly of Fig. 5 are inserted into the transverse apertures 90, 95 and the web 155 is received within the channel 175 with the pin 180 extending through the hole 160.

1. A heat trap for use in a conduit through which fluid flows, the heat trap comprising:
a unitary body having a central bore extending therethrough; and
first and second blocking portions having on a circumferential edge respective first and second resilient hinge portions;
wherein both of the blocking portions substantially entirely block the central bore when in an at-rest condition;
wherein the first and second hinge portions hingedly interconnect the blocking portions to the unitary body in cantilever fashion and permit resilient deflection of the blocking portions on the hinge portions in response to fluid flow through the conduit, and provide for the resilient return of the blocking portions to the at-rest condition in the absence of fluid flow through the conduit;
wherein the first and second hinge portions are circumferentially aligned; and
wherein the unitary body and the first and second blocking portions define therebetween a substantially stagnant zone to resist convective heat transfer from fluid on one side of the stagnant zone to fluid on the other side of the stagnant zone.

2. The heat trap of claim 1, wherein the unitary body has therein first and second transverse apertures that communicate with the central bore, the first aperture being directly above the second aperture, and wherein the first and second hinge portions extend through the respective first and second apertures.

3. The heat trap of claim 2, wherein the unitary body has an outer surface that includes first and second recessed rings that intersect the respective first and second apertures; and wherein each of the resilient hinges has attached thereto a ring portion that is received in the respective first and second recessed rings.

4. The heat trap of claim 2, wherein the unitary body includes an outer surface that includes a channel extending between the first and second apertures; wherein the first and second resilient hinges are joined to each other with a web portion that is received within the channel.

5. The heat trap of claim 4, wherein the channel has therein a pin; wherein the web has a hole; and wherein the pin is received within the hole to resist movement of the web with respect to the channel.

6. The heat trap of claim 1, wherein the unitary body is generally collar-shaped, wherein the first and second resilient hinges are joined to each other with a web portion; and wherein the web portion extends along the length of the unitary body and the blocking portions extend across opposite ends of the unitary body to block the central bore.

7. The heat trap of claim 6, wherein the unitary body includes an outer surface that includes a channel extending the entire length of the unitary body; and wherein the web portion is received in the channel.

8. The heat trap of claim 7, wherein the channel has therein a pin; wherein the web has a hole; and wherein the pin is received within the hole to resist movement of the web with respect to the channel.

9. A heat trap for use in a conduit through which fluid flows, the heat trap comprising:
a unitary body having a central bore extending therethrough, the central bore having a longitudinal axis; and
first and second resilient flappers in the bore and axially spaced from each other along the longitudinal axis of the central bore, each of the flappers having a portion of its perimeter hingedly mounted to the unitary body;
wherein the first and second hinged mounts are circumferentially aligned;
wherein the first and second flappers both substantially entirely block the central bore when in an at-rest condition;
wherein the first and second flappers resiliently deflect about the hinged mount from the at-rest condition to open the central bore in response to fluid flow through the conduit, the flappers resiliently returning to the at-rest condition in the absence of fluid flow through the conduit; and
wherein, in the absence of fluid flow through the conduit, the unitary body and the first and second flappers define therebetween a substantially stagnant zone to resist convective heat transfer from fluid on one side of the stagnant zone to fluid on the other side of the stagnant zone.

10. The heat trap of claim 9, wherein the unitary body includes first and second apertures intersecting the central bore, the first aperture being above the second aperture; and wherein the perimeter portions of the first and second flappers is received in the respective first and second apertures to hingedly mount the flappers to the unitary body.

11. A heat trap comprising:
a unitary body defining a central bore and having an outer surface, first and second transverse apertures through a side of the body and communicating with the central bore, wherein the first aperture is above the second aperture, and first and second circumferential grooves in the outer surface and intersecting the respective first and second apertures; and
first and second flappers, each having a tongue portion, a hinge portion, and a ring portion integrally formed together;
wherein the tongue portions of the first and second flappers extend through the respective first and second apertures, the resilient hinge portions are circumferentially aligned and support the tongues in cantilever fashion for resilient hinged motion within the central bore, and the ring portions are received within the grooves to resist the tongue portions from coming out of the apertures; and
wherein the tongue portions deflect in response to fluid flow within the conduit, but return to an at-rest condition in the absence of fluid flow in the conduit to define a stagnant zone within the bore, the stagnant zone resisting convective currents from flowing thereacross.
